(19) United States
(12) Patent Application Publication
(10) Pub. No.: US 2014/0023569 A1
(43) Pub. Date: Jan. 23, 2014

(54) Suction Device for a Matrix Array of Pipette Tips

(71) Applicants: Torsten Schoeppe, Jena (DE); Adrian Siemers, Jena (DE)

(72) Inventors: Torsten Schoeppe, Jena (DE); Adrian Siemers, Jena (DE)

(73) Assignee: CyBio AG, Jena (DE)

(21) Appl. No.: 13/624,186

(22) Filed: Sep. 21, 2012

Related U.S. Application Data
(60) Provisional application No. 61/674,440, filed on Jul. 23, 2012.

(51) Int. Cl. B01L 99/00

(52) U.S. Cl. 422/552

(57) ABSTRACT

A suction device for a matrix array of pipette tips includes a tray configured to hold a liquid dispensed by the pipette tips. The tray includes an open-pore tray bottom. A suction tray cooperates with the open-pore tray bottom so as to form a vacuum chamber with the open-pore tray bottom forming a constituent of the vacuum chamber. A suction element is indirectly connected to the tray via the vacuum chamber so as to be configured to actively draw liquid over an entire surface into the vacuum chamber by suction via the tray bottom.

### CROSS-REFERENCE TO RELATED APPLICATION

This application claims priority to provisional application No. 61/674,440, filed on Jul. 23, 2012, which is hereby incorporated by reference herein.

The invention relates to a suction device for a matrix array of pipette tips on multipipettors or transfer pins in replication systems.

### BACKGROUND

A suction device of the generic type is described with respect to a rinsing tray system in German patent specification DE 196 35 004 C1.

Multipipettors are employed especially in the realm of research into chemical and biochemical ingredients in order to test a large number of substances (substance libraries) for their efficacy in an envisaged application purpose (HTS: high throughput screening). The highest throughput rates are achieved especially with multipipettors having a matrix array of pipette tips. Currently, such multipipettors with arrays of 8×12=96, 16×24=384 and 32×48=1536 pipette tips are in use.

Here, the trend is towards an ever-increasing number of test substance volumes, which are dispensed onto a microtiter plate (MTP), as well as towards the minimization of the individual test substance volumes.

These tests used to be carried out in microtiter plates whose wells were arranged in a matrix of 8×12=96 wells and which could hold test substance volumes of up to 300 μl per well, but formats involving multiples of this matrix (16×24=384, 32×48=1536 and 64×96=6144) are now acquiring ever-greater significance. The outer dimensions of the microtiter plates used are the same, irrespective of the well matrix, resulting in center distances of 4.5 mm, 2.25 mm and 1.125 mm for the higher formats, starting at the center distance of the wells for the 8×12 matrix. Here, the volume that can be put into each well is disproportionately reduced.

For some time now, replication systems have been used more and more frequently in order to transfer test substances. Replication systems consist of two-dimensionally arranged transfer pins of the same diameter and they likewise serve to transfer test substances in HTS applications. Such systems are often referred to as pin tools. The transfer pins are advantageously configured in such a way that, when they are dipped into a test substance, the test substance is only deposited on their end face in the form of a meniscus. The volume of substance that can be transferred is determined here largely by the diameter of the transfer pins employed and this volume can be considerably smaller than is possible with pipette tips.

A similar requirement, which is made of multipipettors as well as of replication systems, is the cleaning of the pipette tips or of the transfer pins after a transfer cycle of substances (pipette liquid) in order to prevent carry-over and thus falsification of the results in subsequent cycles.

When the pipette tips or transfer pins are to be cleaned, they remain mounted in their fixed arrangement relative to each other on the multipipettor or on the replication system. This arrangement is adapted to the microtiter plate like a matrix in which the axes of the pipette tips are at the same distance from each other as the matrix distances of the microtiter plates. Since the commercially available microtiter plates have the same outer dimensions, irrespective of the number of wells, the containers used for cleaning also have to be at least the same size, so that the pipette tips can be inserted in their fixed arrangement relative to each other. Naturally, these containers can also be used to clean an array consisting of just a single row or else of individual pipette tips and transfer pins.

For the sake of simplicity, the explanations below will only refer to pipette tips. The information provided in this context can be applied to the greatest extent possible to transfer pins by the person skilled in the art.

In the simplest case, for cleaning purposes, the array of pipette tips is lowered into a first container where a clean rinsing liquid is picked up in the pipette tips, then the array is raised and transported to above an adjacent second container, where the rinsing liquid is actively discharged.

Before this backdrop, German patent specification DE 196 35 004 C1 describes a rinsing tray system consisting of a first tray that holds the unused (clean) rinsing liquid and a second tray that holds the contaminated rinsing liquid, whereby the first tray is arranged so as to rest on the second tray, whereby webs with through openings (through holes) are distributed in the matrix spacing over the bottom of a matrix array of pipette tips of a multipipettor.

For purposes of carrying out the rinsing process, the first tray is filled with the clean rinsing liquid through an inlet. An overflow or a filling-level sensor is provided in order to prevent the filling level of the first tray from exceeding the height of the webs, as a result of which the liquid could drain via the through holes into the second tray. The pipette tips are dipped into the clean rinsing liquid, filled with this liquid by means of suction, and emptied again via the through holes, so that the rinsing liquid contaminated with residues of the previously pipetted test substance (pipette liquid) is conveyed to the second tray. In this context, it is immaterial whether the required relative movement is effectuated by moving the rinsing system or the pipette tips.

European patent specification EP 1 070 963 B1 describes a rinsing tray system which has been refined vis-à-vis the above-mentioned rinsing tray system, in which a bottom tray is filled with clean rinsing liquid that is fed via the through holes into the top tray, from which it is then discharged.

For cleaning purposes, the pipette tips are inserted into the through holes of the rinsing tray system. In this process, the stream of clean rinsing liquid generated in the through holes flows around the outer surface of the pipette tips and cleans them. The test substance residues that are released are conveyed by the stream generated by the continuous feed of clean liquid upwards and into the through holes, and subsequently they are rinsed over the edge of these holes. This prevents carry-over and thus contamination of the clean rinsing liquid. A side effect is that the through holes can be spaced closer to each other, thus reducing the matrix spacing in comparison to a rinsing tray system according to the above-mentioned German patent specification DE 196 35 004 C1 since there is no need for ventilation openings.

The center distances between the through holes can be smaller than 9 mm, for example, 4.5 mm, 2.25 mm or 1.125 mm, as a result of which this rinsing tray system is comparatively better suited for multipipettors in which the pipette tips are arranged in a higher density and thus in a greater number. Such a rinsing tray system is very difficult to manufacture—or else only with a disproportionate amount of effort—for a very high number and thus high density of pipette tips, for example, for 1536 pipette tips, which are then arranged in a matrix of 32×48 with a matrix distance of 2.25 mm, or even 6144 pipette tips in a matrix of 64×96 with a matrix distance of 1.125 mm.

Moreover, in any case, like the above-mentioned system, the concrete design of this system means that it is only suitable for a concrete array having a specific matrix distance.

Another problem arises in conjunction with the small dimensions of the pipette tips in arrays of 1556 and more pipette tips, especially with the small inner diameters that only increase slightly from the outlet opening of the pipette tips over the entire length of the pipette tip, as will be explained below.

After the pipette liquid that had previously been picked up from a container has been completely dispensed via the outlet openings of the pipette tips, residues of the pipette liquid adhere not only to the outer surfaces of the pipette tips, but are also left behind in the form of a film of liquid in the outlet openings of the pipette tips. This often happens even when, after the pipette tip has been completely emptied, air is expelled from the outlet opening by moving the plunger of a pipette channel associated with the pipette tip all the way to a lower end position. If the plunger is returned to its upper end position while additional pipette liquid or rinsing liquid is being picked up, this film of liquid does not rupture owing to the virtually constant inner diameter of the pipette tip, and the film of liquid is further drawn into the pipette tip by suction. This can lead not only to carry-over, but also to contamination of the pipette channel associated with the pipette tip in question.

FIGS. 3a and 3b show three pipette tips, namely, one that is empty above a liquid in the left-hand view, one with a film of liquid that has been drawn in by suction in the center view, and one with a ruptured film of liquid which now forms droplets or a still-intact film of liquid that has been drawn in further by suction in the right-hand view. Here, the pipette tip shown in FIG. 3a has a pronounced enlargement approximately in the middle over its length in order to pick up a large pipetting volume. The inner diameter of the pipette tip changes very little until the enlargement, so that any film of liquid that had been drawn in by suction is stretched but not destroyed. The drawn-in film of liquid ruptures in the area of the enlargement. In the case of the pipette tips shown in FIG. 3b, the inner diameter likewise changes only slightly in the beginning and then remains constant. Consequently, a drawn-in film of liquid does not rupture and might be transported all the way to the top end of the pipette tip and further into the associated pipette channel.

Such a pipette channel basically consists of a cylinder and a plunger that runs through it so that they are tightly sealed with respect to each other. A pipette tip is placed with a tight seal onto the pipette channel. The seal must be reliably ensured so that a volume of pipette liquid that is determined exclusively by the plunger stroke can be reproducibly dispensed with a high degree of precision. Since a film of liquid is drawn into the pipette channel by suction, this can give rise to contamination of the seal between the plunger and the cylinder (plunger seal). Numerous technically different solutions are known from the state of the art for sealing the plunger, and their functionality can be compromised in case of contamination.

The cylinder can be configured as a sleeve that is made of an elastic material and that tightly surrounds the plunger, which already achieves a sealing effect. In order to create a matrix array of pipette channels, these sleeves are correspondingly arranged relative to each other in through holes, for example, in a stiff plate. The cylinders can also be formed by the through holes of one or more plates arranged one above the other. The plunger seal is then usually created by means of additional sealing elements such as spring-loaded rings, sealing sleeves and/or O-rings or X-rings.

The sealing of the plunger can also be enhanced or realized by means of viscous lubricants. It is a known procedure to manufacture the cylinder and the plunger with very narrow tolerances, with a minimum amount of play that is filled with lubricant. Here, the surface of the plunger can be rougher in comparison to the surface of the cylinder, or else it can be provided with random or defined inner structures such as encircling grooves. In order to keep the lubricant inside a limited area on the plunger, especially when the tolerances between the cylinder and plunger are greater, the lubricant can be applied between two sealing elements or above a sealing element.

The type of plunger seal employed in each case for the pipette channels depends on a number of factors that would go beyond the scope of this description. In any case, it can be assumed that they are all designed in such a way that they ensure a tight seal in air as the medium, and consequently contact with a pipette liquid might have an undefined influence, which is why such contact that, as explained, could be caused by an undesired drawing in of the film of liquid, should be reliably prevented.

In the case of pipette tips whose inner diameter increases markedly starting at the outlet opening, this film of liquid normally ruptures and forms drops on the inside of the pipette, which also have to be removed in the subsequent washing cycle. Then, pipette liquid is carried over into a conceivably different pipette liquid of a subsequent pipetting step, and no film of liquid can be drawn in by suction all the way to the plunger seal.

By the same token that residues of pipette liquid remain adhering to the pipette tip after the pipette liquid has been completely dispensed, rinsing liquid is also left behind in the pipette tips after completion of a washing cycle of the type carried out according to the state of the art. When new pipette liquid is subsequently picked up, pipette liquid is then carried over, the degree of which depends on the volume of pipette liquid that has been picked up. For this reason, it is fundamentally of interest, irrespective of the dimensions of the pipette tips, whose maximum pick-up volume is limited by their length and their inner diameter, to rid the inner surface of rinsing liquid before new pipette liquid is picked up.

### SUMMARY

In an embodiment, the present invention provides a suction device for a matrix array of pipette tips includes a tray configured to hold a liquid dispensed by the pipette tips. The tray includes an open-pore tray bottom. A suction tray cooperates with the tray bottom so as to form a vacuum chamber. A suction element is indirectly connected to the tray via the vacuum chamber so as to be configured to actively draw liquid over an entire surface into the vacuum chamber by suction via the tray bottom.

### BRIEF DESCRIPTION OF THE DRAWINGS

Exemplary embodiments of the present invention are described in more detail below with reference to the drawings, in which:

FIGS. 1a and 1b show a suction device according to an embodiment of the invention in a perspective view and in a sectional view thereof;

FIGS. 2a and 2b show a suction device according to another embodiment, in a perspective view and in a sectional view thereof; and

FIGS. 3a and 3b show pipette tips having different pick-up volumes, for purposes of illustrating an objective to be achieved.

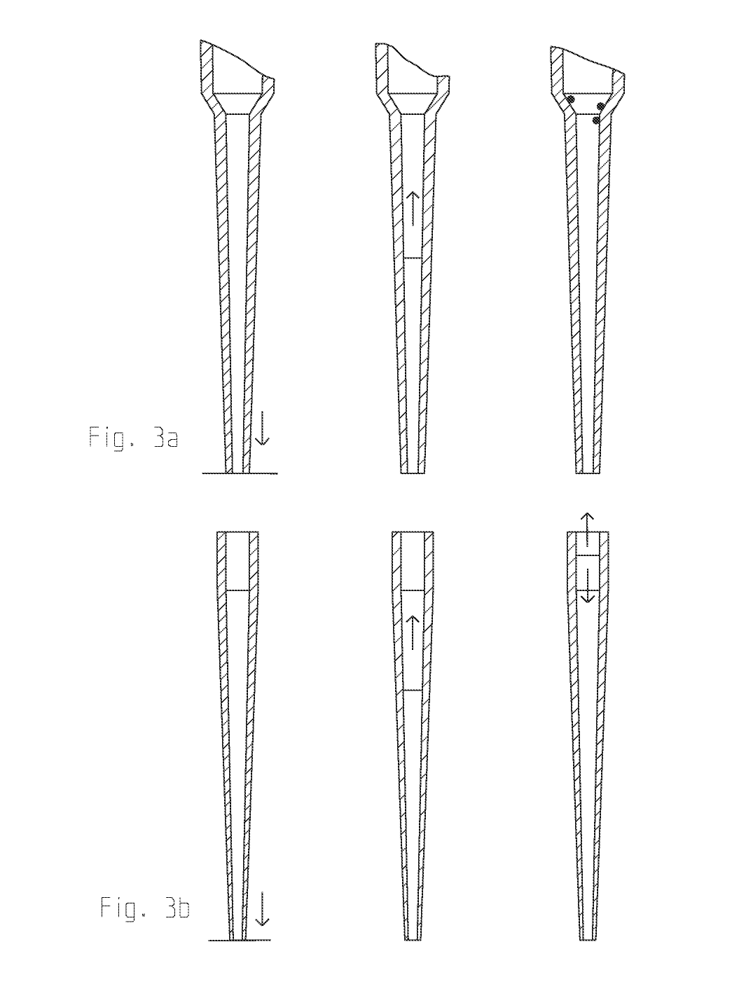

### DETAILED DESCRIPTION

In an embodiment, the present invention provides a suction device with which liquid residues can be reliably prevented from being left behind on the outer and inner surfaces of the pipette tips after the rinsing liquid has been dispensed via the pipette tips of a multipipettor and with which residues of liquid can be removed after the pipette liquid has been dispensed.

Preferably, the design of the suction device is such that it can be used with all familiar arrays of pipette tips, irrespective of their number, their matrix distance and thus their size.

The illustrated embodiments of a suction device according to the invention comprise a tray 1, adjacent to which there is vacuum chamber 2 that is connected to a suction means 8, whereby the tray 1 has an open-pore tray bottom 1.1 that is also a constituent of the vacuum chamber 2.

The tray 1 is therefore connected indirectly to the suction means 8 via the vacuum chamber 2.

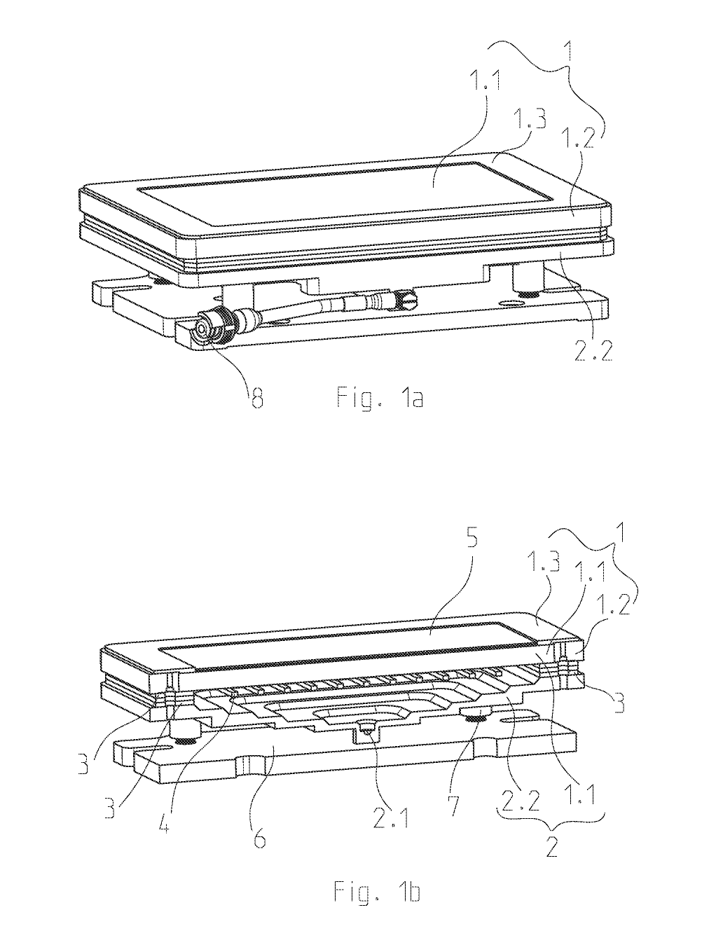

According to an embodiment, shown in FIGS. 1a and 1b, the tray 1 consists of an open-pore tray bottom 1.1, of a tray wall 1.2 that encircles the tray bottom 1.1, and of a hold-down means 1.3 in the form of a frame that is fastened to the tray wall 1.2 and that rests on the tray bottom 1.1 so as to cover its edge.

The vacuum chamber 2 is formed by the tray bottom 1.1 and by a suction tray 2.2. In this embodiment, the suction tray 2.2 is stepped downwards towards the center, as a result of which its depth increases stepwise towards the center, while the suction tray 2.2 and the tray bottom 1.1 enclose a hollow space. The suction tray 2.2 can also be configured in such a way that it has a continuous gradient towards the center.

A connection to the suction means 8 is established via a connector 2.1 that is advantageously provided in the center of the suction tray 2.2. An encircling edge surface of the suction tray 2.2 is screwed to the edge of the tray bottom 1.1 by means of a sealing plate 3. The tray 1 and the vacuum chamber 2 are thus sealed with respect to each other on their encircling edges by means of the sealing plate 3. The connector 2.1 is connected to a suction means 8 by means of which a negative pressure is generated in the vacuum chamber 2, and the tray bottom 1.1 is no longer sealed with respect to this negative pressure, so that a liquid contained in the tray 1 can be actively drawn by suction through the tray bottom 1.1 into the vacuum chamber 2.

Preferably, a Venturi tube that is connected to compressed air can be employed as the suction means 8. Compressed air is available in many laboratories anyway, so that there is no need for additional aggregates. A non-return valve that enhances the efficiency can be provided between the Venturi tube and the connector 2.1, so that the Venturi tube only needs to be switched on briefly each time in order to generate sufficient negative pressure.

The open-pore tray bottom 1.1 can be made of plastic, ceramics, glass or another material that is permeable when negative pressure is present. For the first embodiment of a suction device, the tray bottom 1.1 can be permeable under normal pressure conditions. The negative pressure then brings about a suction force that acts almost uniformly over a large surface area of a liquid or gaseous medium that is in contact with the tray bottom 1.1.

Underneath the tray bottom 1.1, there can advantageously be a mount 4 with an interrupted contact surface, for example, in the form of a grid. Depending on the stiffness of the tray bottom 1.1, which is determined by its material and its thickness, this mount 4 can serve to support the tray bottom 1.1, but it can also be used to advantage since, once negative pressure is applied underneath the tray bottom 1.1, it is easier for drops to be formed on it, which are then removed by suction.

Advantageously, a hydrophilic pad 5 is laid onto the tray bottom 1.1, said pad 5 advantageously also being secured by the hold-down means 1.3 or by an additional hold-down means. Aside from its hydrophilic property, the pad 5 also may be chemically resistant to the liquids employed and may be deformable in such a way that it adapts to the pipette tips when the latter are dabbed by being gently touched against the pad 5. The pad 5 also protects the pipette tips mechanically when they touch it. The pad 5 can be made, for instance, of viscose reinforced with polypropylene or of fiberglass filter paper. The pad 5 is a disposable item and is replaced, for example, after a pre-defined number of cycles or on a daily basis.

Normally, the accessories needed to operate multipipettors such as microtiter plates, reservoirs or washing trays are temporarily carried to the multipipettor by a transport device. For this purpose, the transport device has carriages with spaces for the accessories which have, for instance, adjustment pins or limiting elements in order to ensure a defined placement of the accessory. In order for the accessory to be positioned in a defined manner in the spaces without requiring adjustment, the bottom of the accessory has to be adapted to the space or have an adapter plate that is adapted to the space.

In order to meet this requirement, a suction means 8 according to this embodiment has a baseplate 6 that is connected to the suction tray 2.2 by four soft spring legs 7. This ensures that the tray bottom 1.1 is oriented against the spring force of the spring legs 7 parallel to the ends of the pipette tips, thus ensuring that all of the pipette tips touch the pad 5.

When the pipette tips are dabbed, the pad 5 is not compacted too much since it can deflect against the spring force of the spring legs 7. This prevents a decrease in its permeability that might be caused by compacting. Moreover, a conceivably less-than-ideal parallel orientation of the outlet openings of the pipette tips and of the tray bottom 1.1 can be compensated for, thus ensuring that all of the pipette tips are in contact with the tray bottom 1.1 or, if applicable, with the pad 5.

The suction tray 2.2 can also be rigidly joined to the baseplate 6, or else the suction tray 2.2 has a footprint configured to match the baseplate 6.

The suction device serves to empty pipette tips after rinsing liquid has been picked up. Fundamentally, pipette tips of any conventional size—that is to say, those with conventional pick-up volumes—can be emptied, either individually or in groups, that are arranged in rows or in a matrix in which they were installed on the heads of multipipettors in the above-mentioned arrays. However, the suction device is particularly well-suited for groups of numerous pipette tips which consequently have a smaller matrix distance and thus a smaller diameter and therefore a smaller pick-up volume.

It should be pointed out that the pick-up volume is essentially determined by the diameter, which normally decreases over the length of the pipette tip in the direction of the outlet opening. Even though there are also pipette tips of different lengths, the range of variation is considerably less here, already with an eye towards configuring the handling of the pipette head of a multipipettor to which the pipette tips are attached, independently of the pipette tips. This is why the terms small and large pipette tips refer to their pick-up volume and not to their length.

A washing tray known from the state of the art can be employed to fill the pipette tips. Such a washing tray consists essentially of an active inlet and an active outlet. Fresh rinsing liquid is conveyed into the washing tray via the inlet in one side of the washing tray. In order to ensure a proper through-flow and liquid exchange, the suction mechanism is preferably situated on the opposite side. The suction mechanism is located below the upper edge of the washing tray, thus acquiring the function of limiting the level of liquid in the washing tray. In order to ensure this, the suction rate has to be higher than the feed rate at the inlet.

If the washing tray is going to be moved while it is full, it is advantageous to provide so-called baffle walls. These baffle walls extend beyond the maximum level of the rinsing liquid in order to attenuate the waves created during acceleration and deceleration of the movement. At the same time, the baffle walls do not extend all the way to the bottom in order to ensure that the liquid exchange is unhindered to the greatest extent possible.

In order for the washing tray to be suitable for cleaning arrays of pipette tips involving a very small matrix distance, that is to say, when there is only very little space between the rows of pipette tips, the baffle walls are advantageously made of a plastic strip, for example, of PEEK. In principle, baffle walls can be provided between each row of pipette tips and thus at a distance equal to the matrix distance of the pipette tips.

As was explained in the description of the state of the art, the aspect of completely ridding the pipette tips of all residual liquid, both in terms of residues of pipette liquid and of rinsing liquid, is of great significance. Whether the suction tray is employed for one or the other or for both within the scope of laboratory operations can be decided on the basis of all of the circumstances that are relevant for this.

A preferred use of the suction device in a washing procedure will be described below.

After completion of a pipetting step, the pipette tips are relatively lowered into the tray 1 of the suction device without the plungers of the associated pipette channels being moved in the meantime, and then brought into contact with the pad 5. The pipette tips are dabbed with the pad 5. Merely due to the high capillary forces in the pad 5, the pipette tips are rid of residual liquid, on the outside as well as on the inside, without any further measures being taken.

Tests were carried out with different pipette tips that had been filled with different liquids such as water, DMSO and ethanol, in combination with pads 5 made of different materials such as polypropylene-viscose and glass fibers. Here, it was ascertained that the capillary force is higher than the “holding vacuum” inside the pipette tip and that the pipette tips were completely emptied exclusively through passive suction due to the capillary forces of the pad 5. It was surprisingly found that this also works when the pad 5 still or already has a relatively high content of residual moisture. This means that the pad 5 does not have to be dry in order to achieve a reliable emptying, which cannot be completely ensured even by vacuum suction.

After completion of the dabbing procedure, the plungers are moved to their lower end position. This is assisted by a brief application of negative pressure. However, this is not absolutely necessary since this involves a relatively small amount of liquid that was picked up by the pad 5 during the dabbing procedure and, as mentioned, the pad 5 can also be moist without having its efficacy appreciably impaired. The pipette tips are then relatively lowered into a washing tray and the plungers are raised, preferably into an upper end position, as a result of which rinsing liquid is picked up. Subsequently, the picked-up washing liquid is dispensed into the suction tray. This can be done in that the pipette tips are held above the pad 5 and the rinsing liquid is first displaced from the pipette tip by lowering the plungers, until the plungers have arrived at their lower end position. Subsequently, the pipette tips are brought into contact with the pad 5. At the latest now, negative pressure is applied to the suction tray 2.2. As an alternative, the pipette tips filled with washing liquid can be placed directly onto the pad 5 and the picked-up washing liquid is dispensed by moving the plunger. In parallel to the dispensing of liquid, negative pressure is applied to the suction tray 2.2. The negative pressure removes the washing liquid from the pad 5. Here, too, the capillary effect of the residually moist pad 5 (in conjunction with the negative pressure applied) ensures here that residual liquid is removed. Then, the effect of the suction procedure consists of a combination of suction due to capillary effect and suction due to negative pressure.

The pad 5 is simultaneously rinsed and cleaned by the dispensed washing liquid, so that the pad 5 likewise does not pose the risk of carry-over. The washing process can be repeated as often as desired.

If the decision is made to carry out the washing process in such a way that the emptying speed of the pipette tips is determined only by the capillary effect of the pad 5 or by the suction due to the negative pressure generated—meaning that it cannot happen that liquid is present in the tray 1—then the tray 1 does not have to fulfill the function that is fundamentally associated with a tray. A tray is fundamentally supposed to be able to hold a liquid, at a volume that is determined by the size of its base surface area and by the height of its walls.

If, like here, no volume is supposed to be held in the tray 1, that is to say, the holding capacity of the tray 1 can be zero since the liquid is transported away from the pipette tips directly through the pad 5, then the tray wall 1.2 only has the function of a fastening element for the suction tray 2.2. This function can also be taken over by a hold-down means 1.3 that has a more massive construction.

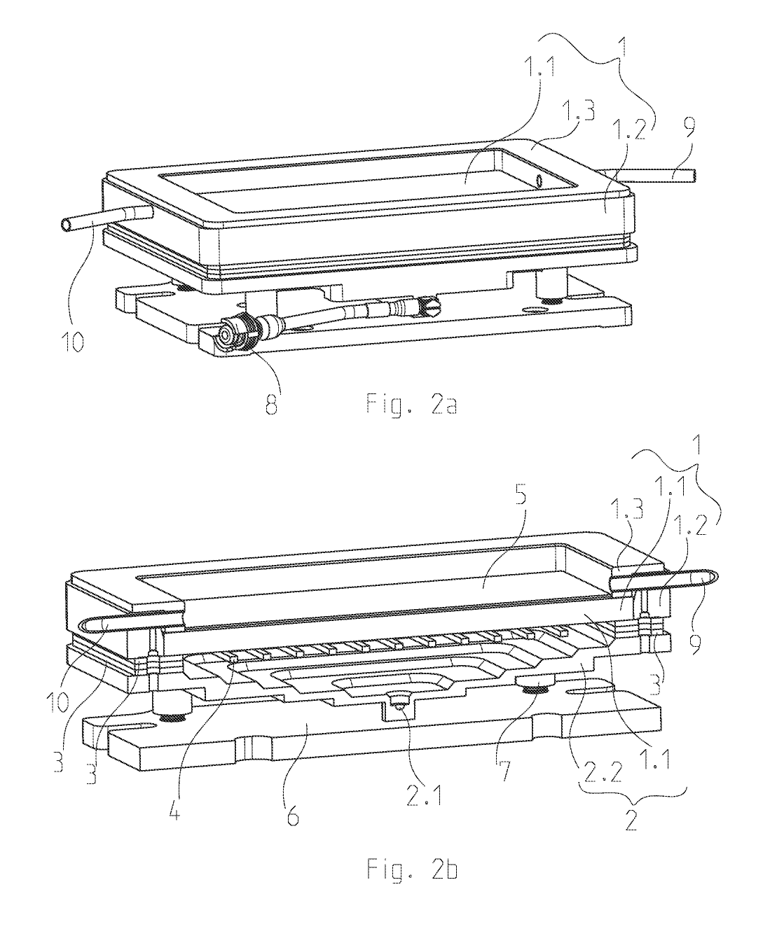

For another embodiment, as shown in FIGS. 2a and 2b, the tray wall 1.2 of the tray 1 defines a holding capacity, so that it can also assume the function of a washing tray, which could especially be of interest if space constraints do not permit two spaces for physically separating the washing tray and the suction device. As a result, the tray wall 1.2 projects beyond the tray bottom 1.1 and has a minimum height so that the tray 1 can hold sufficient rinsing liquid for the cleaning process.

An inlet 10 and preferably also an outlet 9 are provided above the tray bottom 1.1. Optionally, the outlet 9 is installed opposite from the inlet 10 in order to generate a stream that especially promotes the cleaning of the outer surface of the pipette tips. Since the rinsing liquid can also be removed by suction via the tray bottom 1.1, it is likewise possible to do without the outlet 9. Advantageously, a filling level sensor and/or an overflow can be provided. Aside from these differences, a suction device according to the embodiment of FIGS. 2a and 2b can be constructed analogously to the suction device according to the embodiment of FIGS. 1a and 1b and can also be modified in terms of individual features as likewise described.

In this embodiment, the tray bottom 1.1 necessarily has to be made of a material that is not permeable to the rinsing liquid under normal pressure. Preferably, a hydrophobic material is employed for this purpose, or else the tray bottom 1.1 has a hydrophobic surface so that the fed-in washing liquid cannot drain through the tray bottom 1.1 passively, that is to say, without negative pressure being applied.

In order to operate a suction device thus configured, rinsing liquid is pumped into the tray 1 via the inlet 10. During or subsequent to this, the pipette tips are lowered into the tray 1 and rinsing liquid is drawn through the outlet openings by suction into the pipette tips while the plungers are being raised. Subsequently, the rinsing liquid is drained or pumped out via an optionally present outlet 9 or else it is removed by suction through the tray bottom 1.1 by applying a negative pressure. In the case of the latter emptying of the tray 1, the pipette tips can be emptied at the same time while the plungers are being lowered. After the tray 1 has been completely emptied and moisture has been removed from the pad 5, the pipette tips are emptied, as has already been described with reference to a suction device according to a first embodiment.

A suction device according to the second embodiment needs relatively less space and this means that the multipipettor together with the inserted pipette tips does not have to be moved between the suction device and a washing tray, something which would otherwise be necessary.

However, this calls for complete emptying of the rinsing liquid before residual liquid can be removed from the pipette tips by means of capillary forces and negative pressure. For this reason, both embodiments can be more or less advantageous to use, depending on the case in question.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

1 tray
1.1 tray bottom
1.2 tray wall
1.3 hold-down means
2 vacuum chamber
2.1 connector for the suction means
2.2 suction tray
3 sealing plate
4 mount
5 pad
6 baseplate
7 spring leg
8 suction means
9 outlet
10 inlet

What is claimed:

1. A suction device for a matrix array of pipette tips, the suction device comprising:
a tray configured to hold a liquid dispensed by the pipette tips and including an open-pore tray bottom;
a suction tray cooperating with the tray bottom so as to form a vacuum chamber, and
a suction element indirectly connected to the tray via the vacuum chamber so as to be configured to actively draw liquid over an entire surface into the vacuum chamber by suction via the tray bottom.

2. The suction device recited in claim 1, further comprising a mount including an interrupted contact surface, the mount being disposed underneath the tray bottom so as to facilitate the formation of drops in the vacuum cleaner.

3. The suction device recited in claim 1, further comprising a hydrophilic pad disposed on the tray bottom so as to allow passive suction by capillary forces of the pad.

4. The suction device recited in claim 2, further comprising a hydrophilic pad disposed on the tray bottom so as to allow passive suction by capillary forces of the pad.

5. The suction device recited in claim 3, further comprising a baseplate configured to position the suction device in a defined space of a carriage of a transport device, the baseplate being connection to the suction tray by spring legs so as to prevent excessive compression of the pad, which reduces capillary force and permeability of the pad.

6. The suction device recited in claim 4, further comprising a baseplate configured to position the suction device in a defined space of a carriage of a transport device, the baseplate being connection to the suction tray by spring legs so as to prevent excessive compression of the pad, which reduces capillary force and permeability of the pad.

7. The suction device recited in claim 1, wherein the tray includes an inlet disposed above the tray bottom so as to form a washing tray.

8. The suction device recited in claim 2, wherein the tray includes an inlet disposed above the tray bottom so as to form a washing tray.

9. The suction device recited in claim 3, wherein the tray includes an inlet disposed above the tray bottom so as to form a washing tray.

10. The suction device recited in claim 5, wherein the tray includes an inlet disposed above the tray bottom so as to form a washing tray.

11. The suction device recited in claim 1, further comprising a baseplate connected to the suction tray by four soft spring legs so as to ensure that they tray bottom is disposable parallel to ends of the pipette tips.

12. The suction device recited in claim 2, further comprising a baseplate connected to the suction tray by four soft spring legs so as to ensure that they tray bottom is disposable parallel to ends of the pipette tips.

13. The suction device recited in claim 3, further comprising a baseplate connected to the suction tray by four soft spring legs so as to ensure that they tray bottom is disposable parallel to ends of the pipette tips.

14. The suction device recited in claim 5, wherein the spring legs include four soft spring legs so as to ensure that they tray bottom is disposable parallel to ends of the pipette tips.

15. The suction device recited in claim 7, further comprising a baseplate connected to the suction tray by four soft spring legs so as to ensure that they tray bottom is disposable parallel to ends of the pipette tips.
